(19) United States
(12) Patent Application Publication
(10) Pub. No.: US 2016/0004998 A1
(43) Pub. Date: Jan. 7, 2016

(54) Method for the Computer-Implemented Rating of an Industrial Property Right

(71) Applicant: IPR-SYSTEMS UG, Berlin (DE)

(72) Inventors: Dierk-Oliver KIEHNE, Stuttgart (DE); Andreas ZAGOS, Stuttgart (DE)

(73) Assignees: InTraCoM GmbH, Stuttgart (DE); Lighthouse Holding B.V., Halfweg (NL)

(21) Appl. No.: 14/646,748

(22) PCT Filed: Nov. 19, 2013
(86) PCT No.: PCT/EP2013/003479

§ 371 Date: Sep. 6, 2015

(30) Foreign Application Priority Data
Nov. 23, 2012 (DE) 10 2012 022 853.8

(51) Int. Cl. G06Q 10/10; G06F 17/30

(52) U.S. Cl. CPC G06Q 10/10; G06F 17/30528; G06F 17/30507

(57) ABSTRACT

For a method for the computer-implemented rating of an industrial property right using an arrangement (1) of data processing installations that comprises at least one first data processing installation (2, 3, 4), at least one second data processing installation (8), at least one input device (12) and at least one output device (42), provision is made for first features (M1) to be first of all ascertained from the at least one first database (5, 6, 7) and for the first features (M1) to be made available on the second data processing installation (8). Next, indicators (I) from guidelines (9) stored in the second data processing installation (8) are ascertained from the first features (M1). From the indicators (I), a first value (W1) and a range of values (WB) for the property right (S) that is to be rated are ascertained and are output on the output device (42). The second data processing installation (8) is physically separate from the input device (12) and arranged outside the range of access of a user (13).

U.S. Pat. No. 7,962,511 B2 discloses a method for computer-implemented rating of intellectual property rights in which the full text of the property rights are evaluated. This is comparatively complex.

The invention has the object to provide a method for computer-implemented rating of an intellectual property right that delivers good results.

This object is solved by a method with the features of claim 1.

The method is carried out by means of an arrangement of data processing installations. The arrangement of data processing installations comprises at least one first data processing installation in which a first database with first features of the property right is stored, at least one second data processing installation on which rules for rating property rights are stored, at least one input device, and at least one output device. The second data processing installation in which the rules are stored is spatially separated from the input device and outside of an access area of a user. Accordingly, on the one hand, it is possible in a simple way to keep secret the rules and, on the other hand, the rules can be regularly updated. In this context, for example, new knowledge in regard to factors that influence the value of intellectual property rights can be taken into account. Also, the rules can be protected in a simple way from manipulation by third parties. It can be provided that the rules vary based on the reason for performing a rating.

It is provided that for rating an intellectual property right initially first features of the property right to be rated are retrieved from the at least one first database. These first features are then made available to the second data processing installation which, based on the first features, determines indicators for a first value of the property right in an automated fashion. The determination of indicators is carried out in this context by computer implementation based on the rules which are stored in the second data processing installation. Based on the indicators, a first value of the property right to be rated is determined. A value of the property right to be rated can be a qualitative statement, for example, a ranking within a patent portfolio, a comparative illustration and/or a monetary value. In this context, the first value of the property right to be rated can be, for example, the monetary value of the property right in the case of an immediate sale, the value of the property right for financial accounting of the company, or a licence value, i.e., royalties to be paid for a unit of time for an exclusive or a non-exclusive license. These values may deviate from each other. Based on the first value, a value range for the value of the property right to be rated is determined and this value range is then put out in the output device. The value range considers the uncertainty that has occurred upon determination of the indicators as well as information that is not accessible for the property right and that also increases the uncertainty of the determined first value. Additional factors may also be taken into account in determining the value range.

The individual determined indicators can mutually influence each other. It is therefore provided that in the second data processing installation correlations between the first features are stored. These correlations can be, for example, stored in the form of a correlation matrix. The indicators determined based on the rules are advantageously corrected by means of the correlations. In this context, individual indicators can remain unchanged, can be changed relative to the determined value, or, as a result of the value of another indicator, can have an absolute value assigned to it, for example, zero. For example, the value of a property right is zero when the property right has lapsed. When an indicator that concerns the legal status has a value that indicates that the property right has lapsed, for example, all other indicators can be set to zero upon correction based on the correlation matrix.

The input device is advantageously part of a fourth data processing installation. The latter can be a personal computer of a user, for example. In this context, the personal computer comprises at the same time the input device, for example, a keyboard, and the output device, for example, a screen. The input device and the output device can also be combined, for example, in the form of a touchscreen, as it is used in connection with smart phones or tablet personal computers.

Advantageously, the first features of the property right to be rated are retrieved by means of a first data connection between the fourth data processing installation and the at least one first data processing installation. The first features that comprise, for example, bibliographic data, are retrieved accordingly by the fourth data processing installation operated by the user immediately from at least one first data processing installation. The at least one first data processing installation can be, for example, a publicly accessible data processing installation of a patent office, that makes available bibliographic data via the Internet, for example. Alternatively, it can also be provided that the first features are retrieved by the second data processing installation via a second data connection between the second data processing installation and the at least one first data processing installation. The first features therefore must no longer be sent from the fourth data processing installation of the user to the second data processing installation. The second data processing installation is located advantageously in the access area of a service provider offering the service of property rights rating and outside of the access area of the user.

Advantageously, the determination of the first value of the property right to be rated is done in the fourth data processing installation based on the indicators. Accordingly, the computing power required in the second data processing installation can be reduced. The determination of the first value from the indicators can be realized, for example, based on a formula or the like that is made available to the fourth data processing installation. The formula can vary based on the reason for performing a rating. The formula can also be different from user to user and, for example, can take into consideration different industry sectors in which the indicators have a more or less strong effect on the value of the property rights. Advantageously, in the second data processing installation neither the retrieval of the first features nor the determination of the first value based on the indicators is taking place. The second data processing installation advantageously only determines, based on the first features made available to it and based on the rules that are stored in the second data processing installation, the indicators for the first value of the property right to be rated, taking into consideration the rules that are stored in the second data processing installation. Accordingly, in the second data processing installation only the rating step is carried out that is performed on the basis of the rules that are to be kept in secret, to be updated, and to be protected from manipulation.

Advantageously, the fourth data processing installation is connected with a fifth data processing installation in which a fourth database is stored. The fourth database contains in this context information in regard to activation for the user of individual functions of the method for rating an intellectual property right. In this context, for each user, i.e., every client of the service provider, the functions which are available to the client are advantageously saved. Different functions are in this context the rating of the property right based on bibliographic data, the rating of the property right based additionally on expert consultation, and the determination of a possible future development of the value of the property right. It is also possible to provide additional or other functions.

Advantageously, the determination of the value of the property right based on the indicators is carried out based on reference property rights whose value is known, for example, due to an already realized sale. It is provided that, for the reference property rights whose value is known, the first features are retrieved from the at least one first data processing installation, the first features are made available to the second data processing installation, the indicators for the value of the reference property right are determined from the first features and the rules which are stored within the second data processing installation, and, based on the indicators, numerical values of indices are determined. The number of indices is advantageously significantly smaller than that of the indicators. By reducing the indicators to a smaller number of indices, for example, the required storage space for the reference data can be significantly reduced. At the same time, it is possible to compare the property right to be rated with acceptable expenditure with the reference data. By reducing the indicators to a reduced number of indices, a rating is possible even when not all indicators are known. The quantity of required reference data, for example, for different reasons for performing a rating, can also be reduced by reducing the indicators to a smaller number of indices.

The numerical values of the indices and the known value of the reference property right are stored in a second database. Therefore, first features and, based on the first features, indicators are determined for the reference property right like for the property right to be rated. The indicators are then combined under indices whose numerical values are then stored. Advantageously, the determination of the first value of the property right to be rated is based on the determination of the first numerical values for at least two indices of the property right. The determination of the first value of the property right is realized based on the first numerical values of the indices determined for the property right to be rated and based on the first numerical value of the indices determined for the reference property right. Advantageously, in the second database the numerical values for the indices and the value for a plurality of reference property rights are stored. For the determination of the value of a property right, a formula can be generated based on the numerical values of the indices and the respective correlated value. Since this formula in case of a plurality of reference property rights is overdefined, the determination of the formula can be realized, for example, by means of similarity analysis, by means of a recursion method, or by means of Euclidean algorithm, i.e., with consideration of the Euclidean distance of the indices and values.

A simple determination of the value of the property right to be rated is possible when a formula for determination of the first value of the property right to be rated is determined, in particular based on the first numerical values determined for a reference property right for the indices and the known value of the reference property right. Advantageously, when determining the first value of the property right to be rated, a plurality of reference property rights are taken into consideration by means of the first numerical values of their indices and their known value. The determination of the value of the property right to be rated can however also be done in a different way.

In this context, a single formula can be determined from all reference property rights. It can however also be provided that for different sectors, for example, different technology sectors, different regions or the like, different formulas are generated. Advantageously, the formula is updated regularly, in particular after accepting at least one additional reference property right into the second database.

Advantageously, the second database, in which the indices and values of the reference property rights are stored, is updated regularly. The updating process can be realized, for example, as soon as one or several additional reference property rights and their values become known or in regular temporal intervals. The updating process is realized advantageously by determining the first numerical values for the indices for the one or more additional reference property rights and saving the first numerical values of the indices and the known values of the reference property rights in the second database.

Advantageously, the rules that are stored in the second data processing installation are also updated based on the determined first numerical values for the indices of the reference property rights. It can also be provided that the correlations that are stored in the second data processing installation are updated based on the determined first numerical values for the indices of the reference property rights.

Advantageously at least four, in particular precisely four, indices are provided. A first index concerns the owner of the property right, a second index concerns the environment of the property right, a third index the technology of the property right, and a fourth index the relevant legal aspects of the property right. The first index is affected by indicators that concern, for example, the size of the owner of the property right, the competition situation of the owner of the property right, and the market segment in which the owner of the property right is active. The second index can be affected, for example, by indicators that concern the number of property right applications in the environment of the property right, for example, in the respective or similar IPC classes, the application activity or the development of application activity in this field and the like. The third index is affected by indicators which concern the technology itself that is to be protected by the property right, for example, how important this technological field is. The fourth index is affected by the relevant legal indicators, for example, the legal status, i.e., whether the property right has been applied for or has issued and already has completed one or several litigation proceedings such as oppositions or invalidity proceedings, the maximum length of protection of the property right, and the like.

Advantageously, second features for rating an additional value of the property right are determined based on a questionnaire or selections list. The questionnaire or selections list can change in this context depending on the selected reason for performing a rating. The second features can be, for example, determined in the context of an expert consultation. The second features are utilized for determining second numerical values for the indices of the property right. It can be provided to output the first value and the additional value of the property right to be rated separately or as separate value ranges to the operator. Advantageously, the value range of the property right that is output to the operator is determined taking into consideration the first value, determined based on the first features, as well as the value that is determined based on the additional second features.

For determining a possible future value development of the property right, it is provided to determine third features based on answers to a questionnaire or selections list. The third features can be determined also, for example, in the context of expert consultation. The third features are utilized for determining third numerical values for the indices. The future development of the value of the property right to be rated can be output as its own independent value or value range. However, it can also be provided that the first value, the additional value, and the possible future development of the value of the property right to be rated are taken into account in determining a single value range for the value of the property right. This can be individually predetermined as a function of the reason for performing a rating. When determining the value range, also the temporal course of a value or several values can be taken into consideration.

The respective determined value of a property right is advantageously the value of the property right at the point in time of value determination. By means of the determination of the possible future value development, also a value of a future point in time can be determined. In this context it is taken into account that the value of a property right changes over its lifetime, for example, as a result of changing first features or as a result of changing economic factors of influence.

An embodiment of the invention will be explained in the following with the aid of the drawing. It is shown in:

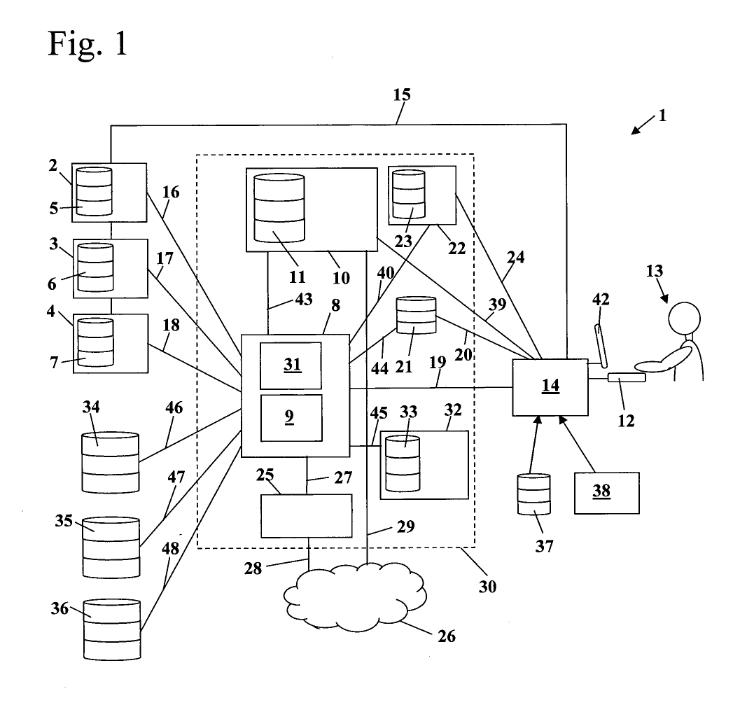

FIG. 1 a schematic illustration of an arrangement of data processing installations;

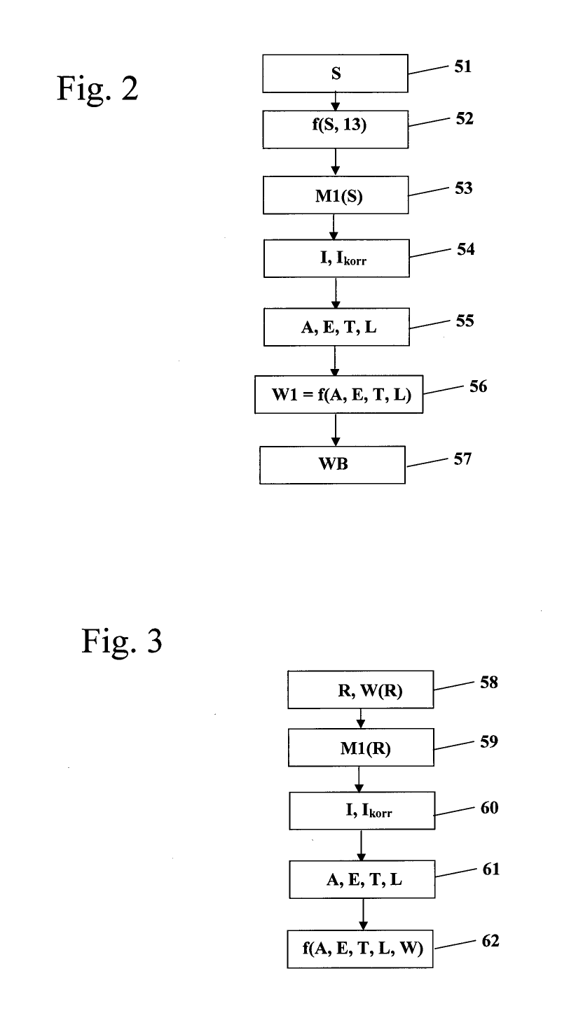

FIG. 2 a schematic illustration of the course of a process for determining a first value of a property right to be rated;

FIG. 3 a schematic illustration of the course of a process for determining a function for the calculation of a first value of a property right to be rated based on a known value of a reference property right;

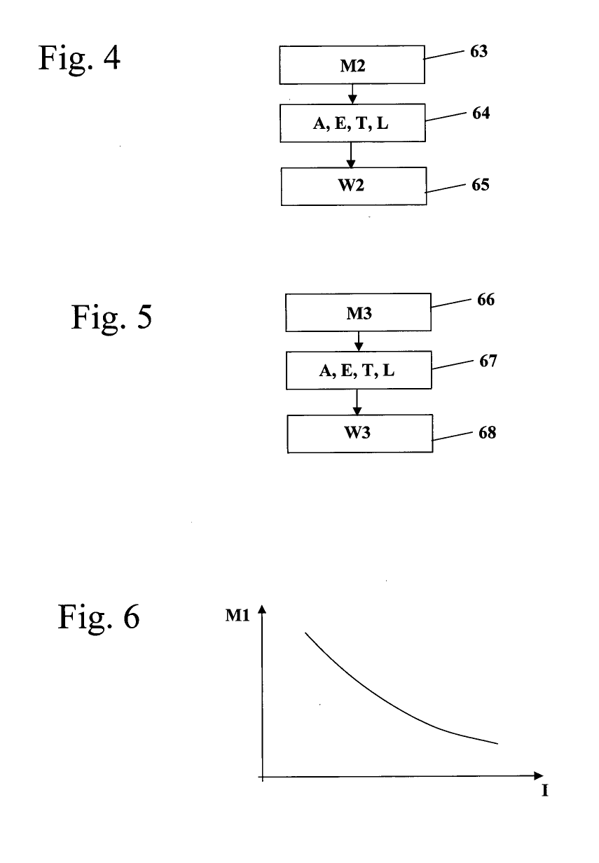

FIG. 4 a schematic illustration of the course of a process for determining an additional value of an intellectual property right, and

FIG. 5 a schematic illustration of the course of a process for determining a future value development of an intellectual property right;

FIG. 6 a schematic illustration of the influence of an indicator on a first feature.

FIG. 1 shows schematically an arrangement 1 of several data processing installations. The arrangement 1 comprises several first data processing installations 2, 3, 4 in which a first database 5, 6, 7 is saved, respectively. The first databases 5, 6, 7 each may be several databases and may also be arranged spatially distributed. The illustration is only schematic here. A first data processing installation 2, 3, 4 can make accessible, for example, a first public database 5, 6, 7 that is made available by a patent office such as the German patent office, the European or American patent office. The first databases 5, 6, 7 contain bibliographic data of property rights such as filing date, status of the examination proceeding, number of claims, IPC class, name of applicant, owner, and inventor, and the like. These data form first feature M1 which affect the value of an intellectual property right S. The first data processing installations 2, 3, 4 are connected by a first data connection 15, for example, the Internet, with a fourth data processing installation 14. The fourth data processing installation 14 is, for example, the personal computer of a user 13. The fourth data processing installation 14 is connected to an input device 12, for example, a keyboard, as well as an output device 42, for example, a screen. The input device 12 and the output device 42 can also be a combined input/output device, for example, a touchscreen. Via the input device 12 the user can input a property right S to be rated, for example, by inputting a number of the property right S. At the output device 42, a determined value of the property right S can be output.

The first data processing installations 2, 3, 4 are connected by second data connections 16, 17, 18 that are, for example, also the Internet, with a second data processing installation 8, i.e., an application server. In the second data processing installation 8 rules 9 are stored that indicate the effect of the first features M1 onto indicators I. In the second data processing installation 8, correlations 31 are also stored which indicate the effect of the magnitude of the individual indicators I on each other. The correlations 31 can be, for example, in the form of a correlation matrix. The second data processing installation 8 is located in the access area of a service provider 30 outside of the access area of the user 13 and is spatially separated from the user 13 and the input device 12 as well as the fourth data processing installation 14.

The second data processing installation 8 is connected by an eleventh data connection 43 with a third data processing installation 10 in which a second database 11, i.e., a reference database, is stored. The third data processing installation 10 with the second database 11 is located advantageously in the access area of the service provider 30 and spatially separated from the user 13 and the fourth data processing installation 14.

The fourth data processing installation 14 is connected by a third data connection 19, which is also advantageously the Internet, with the second data processing installation 8. The fourth data processing installation 14 is also connected by a fourth data connection 20 with a third database 21. The third database 21 can contain, for example, different calculation methods for different reasons of performing a rating, for example, the value in case of liquidation of a company, the value for a usual sale, a value for the evaluation of the company itself or a license value. The calculation method for calculating the license value can be, for example, the type of license to be granted, i.e., an exclusive license or a non-exclusive license, the termination modalities, the number of produced items, and the like. The license value can be, for example, the royalties to be paid annually. These different calculation methods can be, for example, stored by the second data processing installation 8 in the third database 21. The fourth data processing installation 14 is also connected by a fifth data connection 24 with a fifth data processing installation 22 in which a fourth database 23 is stored. The fourth database 23 contains data for client administration, i.e., data for administering different users 13, for example, information in regard to activation of certain functions for rating a property right. The fifth data processing installation 22 is connected by a tenth data connection 40 with the second data processing installation 8. Likewise, the third database 21 is connected by a twelfth data connection 44 with the second data processing installation 8. The fourth data processing installation 14 can also be connected with the third data processing installation 10 in which the second database 11 with reference data is stored, namely by a ninth data connection 39. The fourth data processing installation 14 can also be connected with one or several additional external databases 37 as well as one or several foreign systems 38, for example, a patent management system or the like that can also function as an input device and can supply numbers of property rights S to be rated by means of the fourth data processing installation 14 to the second data processing installation 8. A number of a property right S to be rated can be, for example, the application number, the official serial number, the publication number, the patent number or the like.

The second data processing installation 8 is connected by a sixth data connection 27 with a sixth data processing installation 25. The sixth data processing installation 25 can be within the access area of the service provider 30. The sixth data processing installation 25 is advantageously connected by a seventh data connection 28 with a data processing installation that provides external computing power 26. This can be, for example, a commercial provider of computing power 26. The sixth data processing installation 25 contains a formula generator, in particular a learning algorithm, which based on indices A, E, T, L, and the value W of already sold or otherwise rated reference property rights R calculates a formula f for calculating a value of a property right S to be rated. This can be, for example, realized by similarity analysis by a similarity generator that is also stored in the sixth data processing installation 25. For generating the formula f, another suitable method can be employed also. In order to keep the expenditure at the service provider 30 minimal, the external computing power 26 is utilized for the computation-expensive step of formula generation.

The second data processing installation 8 is connected by a thirteenth data processing connection 45 with a seventh data processing installation 32 in which a fifth database 33 is stored. The seventh data processing installation 32 serves for generating future scenarios for the possible future development of the value of a property right S to be rated. For this purpose, advantageously a plurality of experts are consulted. The experts are consulted in regard to different factors of influence on a certain field of technology. Following a first expert consultation, second expert consultation may be carried out in which the experts know the answers of other experts to the questions put to them. Based on the data obtained by the expert consultations, influencing factors on the possible future value development of property rights are calculated and saved in the fifth database 33.

In the embodiment, the third data processing installation 10 is also connected with the external computing power 26, in particular by an eighth data connection 29 that may also be the Internet.

The second data processing installation 8 is moreover connected by a fourteenth data connection 46, in particular the Internet, with a currency database 34. Accordingly, the determined value can be output in different desired currencies and the known values of the reference property rights can be based on a reference currency. The second data processing installation 8 is also connected by a fifteenth data connection 47 with an information database 35 that, for example, may contain economic data of different countries and the like. This may also be several information databases that, for example, make available statistical data of a country. The data obtained from the information database 35 can be utilized in order to evaluate the effect on the protected technology of the countries in which a patent is valid.

By means of a sixteenth data connection 48 the second data processing installation 8 is moreover connected with one or several company databases 36, advantageously also through the Internet. From the company database 36 company data such as, for example, company size, volume of sales, volume of sales within the field of technology related to the property right, and the like can be acquired.

FIG. 2 shows the course of a process for determining a first value of a property right S to be rated. In method step 51 the operator 13 inputs the number of the property right S to be rated at the input device 12. Alternatively, the number of a property right S to be rated can also be made available by a program, for example, a foreign system 38 such as a patent management system. In a second method step 52, the fourth data processing installation 14, with which the input device 12 is connected and on which a corresponding computer program is stored, retrieves from the third database 21, based on the property right number of the property right S to be rated, a formula f for determining the first value of the property right S to be rated. The formula f depends advantageously on the property right S, for example, the field of technology, in particular the IPC class of the property right S as well as on the operator 13, i.e., on the company size, for example, of the operator 13, or the like.

In a subsequent method step 53, the fourth data processing installation 14 retrieves via the first data connection 15 the first features M1 from the first databases 5, 6, 7. Retrieving the formula f and the first features M1 in the method steps 52 and 53 can also be done simultaneously or in a different sequence. Instead of via the first data connection 15, the first features M1 can also be retrieved from the second data processing installation 8 via the second data connections 16, 17, 18. For this purpose, the fourth data processing installation 14 sends via the third data connection 19 a number of a property right S to be rated to the second data processing installation 8. The first features M1 are then made available at the second data processing installation 8. This can either be done in that the second data processing installation 8 itself retrieves the first features M1 from the first databases 5, 6, 7 or in that the first features M1 which have been retrieved by the fourth data processing installation 14 are sent from the fourth data processing installation 14 through the third data connection 19 to the second data processing installation 8.

In a fourth method step 54, the second data processing installation 8 determines indicators I from the first features M1, based on the rules 9 which are stored in the second data processing installation 8. The rules 9 can vary based on the reason for performing the rating. The indicators I are subsequently corrected based on the correlations 31 that are also stored in the second data processing installation 8. Based on the corrected indicators I_{corr} indices A, E, T, L are determined in a fifth method step 55. It can also be provided that the indicators I are not corrected but immediately utilized for determining the indices A, E, T, L. The indices A, E, T, L can be determined in the second data processing installation 8. Advantageously, the corrected indicators I_{corr} are however transmitted via the third data connection 19 to the fourth data processing installation 14 and the determination of the indices A, E, T, L is realized in the fourth data processing installation 14 at the user. In this way, the computing power which is required at the service provider 30 is reduced. It is also possible to provide other indices than the indices A, E, T, L or additional indices.

The indices A, E, T, L comprise a first index A, the determination of which takes into account indicators I_{corr} concerning the owner of the property right S. The determination of a second index E takes into account indicators I_{corr} that concern the environment of the property right S, for example, the number of applications in the respective IPC class and the like. The third index T takes into account the technology of the property right S, for example, indicators I_{corr} that concern the IPC class or the like. The fourth index L combines indicators I_{corr} which concern the relevant legal aspects of the property right S, for example, the legal status, number of conducted litigations and the like.

Based on the determined numerical values for the indices A, E, T, L, in a sixth method step 56 a first value W1 is calculated by means of the formula f. In a seventh method step 57, based on the first value W1 as well as the imprecision in determining the first features M1 and the indicators I, in particular due to missing first features M1 or missing indicators I, a value range WB for the value of the property right S is determined. The determination of the value range WB may also take into account an additional value W2 as well as a possible future value development W3 which will be explained in more detail in the following. The value range WB is output subsequently at the output device 42. The output can be a numerical value with value range. In this context, also different factors of influence on the different possible value developments of the property right S can be output. The possible future value development can be output as a trend in a graphic illustration.

FIG. 3 shows the process for determining a formula f for the calculation of the first value W1. In the second database 11, for at least one reference property right R the actual value W of the reference property right R as well as the property right number of the property right R are stored. Advantageously, a plurality of reference property rights R with their actual value W, which, for example, may be an actually obtained sales price, can be stored. The second database 11 is advantageously updated continuously by adding additional reference property rights R as well as their actual values W. This is done in an eighth method step 58. In a subsequent method step 59, first features M1 are determined for the stored reference property rights R or a newly added reference property right R. Determining the first features M1 is advantageously carried out by the second data processing installation 8 that, for this purpose, retrieves or obtains the number of the reference property right R via the eleventh data connection 43 and determines the first features M1 based on the first databases 5, 6, 7.

In the following method step 60, indicators I are determined from the first features M1 of the reference property rights R based on the rules 9. The determination is realized in the second data processing installation 8. The determined indicators I are corrected based on the correlations 31. In a subsequent method step 61, the indices A, E, T, L are determined based on the corrected indicators I_{corr}. This is realized in the same way as with a property right S to be rated. The determination of the indices A, E, T, L can be realized alternatively in the second data processing installation 8 or in the third data processing installation 10. Based on the determined indices A, E, T, L, a formula f is generated in the sixth data processing installation 25 in a method step 62. This formula f considers the indices A, E, T, L as well as the actual value W of the reference property rights R. The formula f is advantageously sent back to the second data processing installation 8 which saves the formula via the twelfth data connection 44 in the third database 21. From here, the formula f can be retrieved by the fourth data processing installation 14 of the user. For determining the formula f, all or only selected reference property rights R with their indices A, E, T, L and their value W can be taken into consideration.

In order to take into consideration additional influences on the value of a property right S to be rated, the determination of an additional value W2 of a property right S based on an expert consultation is provided according to FIG. 4. For this purpose, in a method step 63 second features M2 are determined based on answers in response to a questionnaire or selections list. These second features M2 are determined in the context of an expert consultation. Based on the second features M2, in a further method step 64 second numerical values for the indices A, E, T, L are determined. These second numerical values for the indices A, E, T, L are utilized in a further method step 65 for determining an additional value W2 of the property right. This additional value W2 can be used in determining the value range WB of the property right S to be rated in method step 57. The second features M2 are advantageously input in method step 63 in the second data processing installation 8 and the determination of the indices A, E, T, L is realized advantageously also in the second data processing installation 8.

FIG. 5 shows a method for determining a future value development W3 of an intellectual property right. In the method step 66, third features M3 are determined. The third features M3 are determined, for example, in the context of an expert consultation. The determination is realized advantageously in the context of a Delphi method in which the interviewed experts in the second series of questions already know the answers of other experts to the questions. The determined third features M3 are advantageously collected and saved in the fifth database 33. Based on the third features M3, the seventh data processing installation 32 or the second data processing installation 8 determines third numerical values for the indices A, E, T, L in a method step 67. In a method step 68, based on the third numerical values for the indices A, E, T, L, a possible future value development W3 for the property right S is determined. The possible future value development W3 can be directly processed in the form of text modules and/or graphically processed, for example, as a trend. The possible future value development W3 can also be taken into account in method step 57 (FIG. 2) for determining the value range WB for the property right S to be rated.

FIG. 6 shows schematically an exemplary correlation between an indicator I and a feature M1. The indicator I can be, for example, the age of the property right. The older the property right, the lower the value of the property right in the exemplary illustration. Accordingly, the magnitude of the first feature M1 decreases with increasing age of the property right. Depending on the type of the indicator I, the correlation between the first feature M1 and indicator I can be increasing or decreasing. In this context, linear or curve-shaped, for example, exponential correlations are possible. Any other correlations are possible also. For example, a first feature M1 can have a first magnitude when the indicator I is below a defined value and a second magnitude when the indicator I is above the defined value. The correlation between the first features M1 and the indicators I generates the rules 9.

What is claimed is:

1. A method for computer-implemented rating of an intellectual property right, wherein the property right (S) has features (M1, M2, M3) that affect the value (W, W1, W2, W3) of the property right (S), wherein the method is performed on an arrangement (1) of data processing installations, wherein the arrangement (1) of data processing installations comprises
at least one first data processing installation (2, 3, 4), in which at least a first database (5, 6, 7) is stored, wherein the features (M1, M2, M3) comprise first features (M1) which are stored in the at least one first database (5, 6, 7),
at least one second data processing installation (8) in which rules (9) for property right rating are stored, wherein the rules (9) indicate the effect of the magnitude of the first features (M1) on the value (W, W1, W2, W3) of the property right (S),
at least one input device (12) configured to accept input from a user (13) in the form of the number of a property right (S) to be rated,
and at least one output device (42),
wherein the input device (12), the output device (42), the at least one first data processing installation (2, 3, 4) and the at least one second data processing installation (8) are connected to each other by at least one data connection (15, 16, 17, 18, 19) at least temporarily, and wherein the second data processing installation (8) is spatially separated from the input device (12) and is arranged outside of the access area of the user (13),
wherein the method comprises the following steps:
retrieving first features (M1) of the property right (S) to be rated from the at least one first database (5, 6, 7),
making available the first features (M1) to the second data processing installation (8),
determining indicators (I) for a first value (W1) of the property right (S) to be rated from the first features (M1) and based on the rules (9) stored in the second data processing installation (8),
determining the first value (W1) of the property right (S) to be rated by utilizing the determined indicators (I);
determining a value range (WB) based on the first value (W1) of the property right (S) to be rated;
outputting the value range (WB) at the output device (42).

2. The method according to claim 1, further comprising storing in the second data processing installation (8) correlations (31) between the first features (M1), and correcting the indicators (I) determined based on the rules (9) based on the correlations (31).

3. The method according to claim 1,
wherein the input device (12) is part of a fourth data processing installation (14) of the arrangement of data processing installations.

4. The method according to claim 3, further comprising retrieving the first features (M1) of the property right (S) to be rated via a first data connection (15) provided between the fourth data processing installation (14) and the at least one first data processing installation (2, 3, 4).

5. The method according to claim 1,
further comprising retrieving the first features (M1) of the property right (S) to be rated by the second data processing installation (8) via a second data connection (16, 17, 18) provided between the second data processing installation (8) and the at least one first data processing installation (2, 3, 4).

6. The method according to claim 3,
further comprising determining the first value (W1) of the property right (S) to be rated from the indicators (I) in the fourth data processing installation (14).

7. The method according to claim 3,
further comprising connecting the fourth data processing installation (14) with a fifth data processing installation (22) of the arrangement of data processing installations in which a fourth database (23) is stored that contains information in regard to activation of functions for the user (13).

8. The method according to claim 1,
further comprising:
storing a second database (11) in at least one third data processing installation (10) of the arrangement (1) of data processing installations if, wherein the third data processing installation (10) is connected via at least one data connection (42) at least temporarily with the second data processing installation (8),
retrieving the first features (M1) for at least one reference property right (R) whose value (W) is known from the at least one first database (5, 6, 7),
making available the first features (M1) to the second data processing installation (8);
determining indicators (I) for the value (W) of the reference property right (R) from the first features (M1) and based on the rules (9) stored in the second data processing installation (8);
determining a first numerical value for at least two indices (A, E, T, L) of the reference property right (R), wherein for the determination of the first numerical value of the indices (A, E, T, L) the indicators (I) are utilized;
saving the first numerical values of the indices (A, E, T, L) and of the known value (W) of the reference property right (R) in the second database (11).

9. The method according to claim 8, further comprising determining the first value (W1) of the property right (S) to be rated by determining first numerical values of at least two indices (A, E, T, L) of the property right (S) and by subsequently determining the first value (W1) of the property right (S) based on the first numerical values of the indices (A, E, T, L) determined for the property right (S) to be rated and based on the first numerical values of the indices (A, E, T, L) determined for the at least one reference property right (R), wherein for determining the first numerical values of the indices (A, E, T, L) of the property right (S) to be rated the indicators (I) determined for the property right (S) to be rated are utilized.

10. The method according to claim 9, further comprising, based on the first numerical values for the indices (A, E, T, L) determined for at least one reference property right (R) and the known value (W) of the reference property right (R), determining a formula (f) for determining the first value (W1) of the property right (S) to be rated based on the indices (A, E, T, L).

11. The method according to claim 10, further comprising updating the formula (f) after accession of at least one additional reference property right (R) into the second database (11).

12. The method according to claim 10,
further comprising, for property rights (S) to be rated of different fields, determining different formulas (f) for calculating the first value (W1), wherein for determining each formula (f) reference property rights (R) of the respective fields are utilized.

13. The method according to claim 8,
further comprising updating the second database (11) by determining first numerical values for the indices (A, E, T, L) for additional reference property rights (R) whose value (W) is known, respectively, and saving the first numerical values of the indices (A, E, T, L) and the known values (W) of the reference property right (R) in the second database (11).

14. The method according to claim 8,
further comprising updating the rules (9) stored in the second data processing installation (8) based on the determined first numerical values for the indices (A, E, T, L) of the reference property rights (R).

15. The method according to claim 8,
further comprising updating the correlations (31) stored in the second data processing installation (8) based on the determined first numerical values for the indices (A, E, T, L) of the reference property rights (R).

16. The method according to claim 8,
further comprising providing at least four indices (A, D, T, L), wherein a first index (A) concerns the owner of the property right (S, R), a second index (E) concerns the environment of the property right (S, R), a third index (T) concerns the technology of the property right (S, R), and a fourth index (L) concerns the relevant legal aspects of the property right (S, R).

17. The method according to claim 8,
further comprising determining second features (M2) based on answers to a questionnaire or selections list, utilizing the second features (M2) for determining second numerical values for the indices (A, E, T, L) of the property right (S), utilizing the second numerical values for the indices (A, E, T, L) for determining an additional value (W2) of the property right (S) to be rated, and taking into consideration the additional value (W2) in determining the value range (WB) of the property right (S).

18. The method according to claim 8,
further comprising determining third features (M3) based on answers to a questionnaire or selections list concerning the future value development of the property right (S), utilizing the third features (M3) for determining third numerical values for the indices (A, E, T, L), utilizing the third numerical values for the indices (A, E, T, L) for determining a future possible development of the value (W3) of the property right (S) to be rated, and taking into consideration the possible future development of the value (W3) in determining the value range (WB) of the property right (S).
